(19) United States
(12) Patent Application Publication
(10) Pub. No.: US 2015/0144840 A1
(43) Pub. Date: May 28, 2015

(54) PROCESS FOR DEEP CONTAMINENT REMOVAL OF GAS STREAMS

(71) Applicant: SHELL OIL COMPANY, Houston, TX (US)

(72) Inventor: Diego Patricio Valenzuela, Amsterdam (NL)

(21) Appl. No.: 14/411,941

(22) PCT Filed: Jul. 3, 2013
(86) PCT No.: PCT/EP2013/064005

§ 371 Date: Dec. 30, 2014

Related U.S. Application Data
(60) Provisional application No. 61/667,669, filed on Jul. 3, 2012.

(51) Int. Cl. C10L 3/10; C01B 17/04; B01D 53/14

(52) U.S. Cl. CPC C10L 3/103; B01D 53/1406; C01B 17/0404; C10L 3/104; C10L 2290/541; C10L 2290/12
USPC 252/372

(57) ABSTRACT

A process for removing sulfur-containing contaminants from a gas stream comprising:
providing a gas stream to a first absorption unit; providing a hydrogen sulfide lean gas stream to a second absorption unit; providing a first regenerator with a hydrogen sulfide rich absorbent from the first absorption unit; providing the hydrogen sulfide rich gas to a Claus unit to convert the hydrogen sulfide to obtain sulfur and a Claus tail gas; providing a second regenerator with an absorbent rich in organic sulfur compounds and in carbon dioxide; fully oxidizing all sulfur species of a gas stream rich in organic sulfur compounds and in carbon dioxide; cooling a sulfur dioxide rich stream; providing a third absorption unit with the sulfur dioxide rich gas stream; and providing a third regenerator with a sulfur dioxide rich absorbent from the third absorption unit.

The present invention relates to a process for removing sulfur-containing contaminants from a gas stream. The method is particularly useful when the ratio of hydrogen sulfide to carbon dioxide is such that enrichment of hydrogen sulfide is required to remove the hydrogen sulfide.

One of the gas streams that require deep removal of contaminants is natural gas. Natural gas comprising H2S and organic sulfur contaminants can originate from various sources. For example, numerous natural gas wells produce sour natural gas, i.e. natural gas comprising H2S and optionally other contaminants. Natural gas is a general term that is applied to mixtures of light hydrocarbons and optionally other gases (nitrogen, carbon dioxide, helium) derived from natural gas wells. The main component of natural gas is methane. Further, often other hydrocarbons such as ethane, propane, butane or higher hydrocarbons are present.

The removal of sulphur-containing compounds from natural gas streams comprising such compounds has always been of considerable importance in the past and is even more so today in view of continuously tightening environmental regulations. Considerable effort has been spent to find effective and cost-efficient means to remove these undesired compounds. In addition, such gas streams may also contain varying amounts of carbon dioxide which depending on the use of the gas stream often have to be removed at least partly.

It is known in the art to sweeten natural gas by treatment of the gas using one of the various alkanolamines that are available for this purpose. Generally, amines in aqueous solutions are applied, which may contain chemical additives to enhance certain characteristics of the absorbent. Amine has gained widespread acceptance and popularity because it can produce a natural gas product that reliably meets the strict requirements for gas purity and is relatively inexpensive. One of the longest known and applied absorbent is the primary amine monoethanol amine (MEA). Currently, methyldiethanol amine (MDEA) is one of the most used absorbents to sweeten natural gas comprising sulfur containing compounds.

The amine absorption process results in a cleaned gas stream and a gas stream comprising the sulfur contaminants and carbon dioxide. Typically, carbon dioxide is not separated from the gas stream, but the gas stream is sent directly as a feed to a sulfur recovery unit. As sulfur recovery step, the Claus process is frequently used. The multi-step process produces sulphur from gaseous hydrogen sulphide.

The Claus process comprises two steps. The first step is a thermal step and the second step is a catalytic step. In the thermal step, a portion of the hydrogen-sulphide in the gas is oxidized at temperatures above 850° C. to produce sulphur dioxide and water:

2H2S+3O2→2SO2+2H2O (I)

In the catalytic step, the sulphur dioxide produced in the thermal step reacts with hydrogen sulphide to produce sulphur and water:

2SO2+4H2S→6S+4H₂O (II)

The gaseous elemental sulfur produced in reaction (II) can be recovered in a condenser, initially as liquid sulfur before further cooling to provide solid elemental sulfur. In some cases, the catalytic step and sulfur condensing step can be repeated more than once, typically up to three times to improve the recovery of elemental sulfur.

The second catalytic step of the Claus process requires sulfur dioxide, one of the products of reaction (I). However, hydrogen sulfide is also required. Typically approximately one third of the hydrogen sulfide gas is oxidised to sulfur dioxide in reaction (I), in order to obtain the desired 1:2 molar ratio of sulfur dioxide to hydrogen sulfide for reaction to produce sulfur in the catalytic step (reaction (II)). The residual off-gases from the Claus process may contain combustible components and sulfur-containing compounds, for instance when there is an excess or deficiency of oxygen (and resultant overproduction or underproduction of sulfur dioxide). Such combustible components can be further processed, suitably in a Claus off-gas treating unit, for instance in a Shell Claus Off-gas Treating (SCOT) unit.

The overall reaction for the Claus process can therefore be written as:

2H2S+O2→2S+2H2O (III)

Thus the Claus process converts the sulfur containing species. However, in some cases also carbon dioxide is present in the stream to the Claus unit, in large amounts. Carbon dioxide is an inert gas that does not participate in the Claus reactions, but because of the thermodynamics of the Claus process, carbon dioxide will detrimentally affect the reaction to produce sulfur. The presence of carbon dioxide dilutes the reactants—hydrogen sulfide, organic sulfur compounds, oxygen, sulfur dioxide, retarding the reaction and reducing the percentage conversion to sulfur. The dilution effect directly influences the chemical equilibrium of the Claus process. In cases where the gas feed to the SRU is rich in hydrogen sulfide, the effect of dilution by carbon dioxide might not be noticed. However, in cases where the quantity of carbon dioxide exceeds the amount of hydrogen sulfide by a factor five or more, the effect on the thermodynamic equilibrium can already be noticed.

Another effect of the dilution of hydrogen sulfide by large amounts of carbon dioxide is that the flame stability in the Claus burner is not guaranteed. Carbon dioxide is used as an effective fire extinguishing chemical, and when present in excessive amounts in the reaction furnace it can inhibit combustion, and even quench the flame completely. The dilution effect of carbon dioxide will reduce the flame temperature in the Claus furnace to the extent that complete combustion of other sulfur compounds, such as organic sulfur compounds and mercaptans, does not occur. This might be solved by the addition of a carbon containing feed to improve combustion and maintain a sufficient flame temperature in the Claus combustion furnace. The disadvantage of adding for example natural gas to the flame is that there might by undesirable side products formed, like carbonyl sulfide and carbon disulfide. These are the products of the reaction between methane and other hydrocarbons, carbon dioxide, hydrogen sulfide and oxygen, and although they may be present in the furnace effluent concentrations of less than 1%, they effectively bind up a portion of the sulfur which does not completely hydrolyse back to hydrogen sulfide in the catalytic zone of the Claus unit, thus reducing the overall conversion of hydrogen sulfide to sulfur.

In conventional line-ups for deep removal of contaminants, with low hydrogen sulfide to carbon dioxide ratios, the feed is first treated in an absorption unit using a solvent formulated for deep removal of all contaminants in the feed, thereby producing an on-spec hydrocarbon stream. The acid gases coming from the regenerator of the first unit require enrichment of hydrogen sulfide as compared to carbon dioxide. Therefore, the gases are treated in a second absorption unit containing an absorbent that is specific for hydrogen sulfide absorption. This second unit acts as an enrichment unit whose primary role is to produce a gas that contains such amounts of hydrogen sulfide compared to carbon dioxide that they are suitable to be converted to sulfur in a conventional Claus unit. These units are designed to take advantage of the kinetic effects to enhance the enrichment process. Rejected gases comprise mostly carbon dioxide and are expected to be ready to vent after incineration.

Such a conventional line-up is for example described in CA-A-2461952. It describes a process for the enrichment of acid gases. The gas coming from the first high pressure absorber is the sweet gas. The rich amine is sent to a second absorber, where it is mixed with recycled acid gas to improve the hydrogen sulfide to carbon dioxide ratio. Then the rich amine is regenerated and the acid gas coming from this regenerator is sent to the sulfur recovery unit or returned to the second absorber. Carbon dioxide is excluded at two points in the process: firstly, the carbon dioxide is only partly absorbed in the high pressure absorber and a portion of the carbon dioxide slips in the feed gas, and secondly carbon dioxide is slipped by the amine in the second absorber, where it is removed overhead as essentially pure carbon dioxide, saturated with water.

The problem with these conventional line-ups is that if other sulfur contaminants, besides hydrogen sulfide, are present, like organic sulfur compounds, such as carbonyl sulfides (COS), mercaptans (RSH), carbon disulfide (CS2), and also benzene, toluene and xylene (BTX) might be present, these compounds end up in the rejected carbon dioxide stream coming out of the enrichment unit. This carbon dioxide stream needs extra treatment steps to decrease its sulfur content before incineration and venting. However, since the organic sulfur compounds and also the BTX has similar properties as carbon dioxide with respect to interaction with solvents, removal is difficult using the current commercially available solvent based processes.

It is an object of the invention to provide a process wherein sulfur-containing contaminants are removed from a gas stream in a more efficient way.

It is a further object of the invention to provide a process wherein the enrichment process of hydrogen sulfide over carbon dioxide is improved.

To this end, the invention provides a process for removing sulfur-containing contaminants from a gas stream, the process comprising the steps of: (a) providing a gas stream comprising natural gas, hydrogen sulfide, organic sulfur compounds and carbon dioxide to a first absorption unit, resulting in a hydrogen sulfide lean gas stream and a hydrogen sulfide rich absorbent; (b) providing the hydrogen sulfide lean gas stream to a second absorption unit, resulting in a cleaned gas stream and an absorbent rich in organic sulfur compounds and in carbon dioxide; (c) providing a first regenerator with the hydrogen sulfide rich absorbent from the first absorption unit, to obtain a lean absorbent and a hydrogen sulfide rich gas stream; (d) providing the hydrogen sulfide rich gas to a Claus unit comprising a Claus furnace and a Claus catalytic stage to convert the hydrogen sulfide to obtain sulfur and a Claus tail gas; (e) providing a second regenerator with the absorbent rich in organic sulfur compounds and in carbon dioxide to obtain a lean absorbent and a gas stream rich in organic sulfur compounds and in carbon dioxide; (f) fully oxidizing all sulfur species of the gas stream rich in organic sulfur compounds and in carbon dioxide to obtain a sulfur dioxide rich gas stream; (g) cooling of the sulfur dioxide rich stream to obtain steam, water and a cooled sulfur dioxide rich gas stream; (h) providing a third absorption unit with the sulfur dioxide rich gas stream to obtain a sulfur dioxide rich absorbent and sulfur dioxide lean gas stream; and (i) providing a third regenerator with the sulfur dioxide rich absorbent from the third absorption unit, to obtain a lean absorbent and a purified sulfur dioxide gas stream.

In accordance with the present invention gas streams can be obtained that contain such small amounts of sulphur-containing contaminants that they can advantageously directly be vented into the air or used for different purposes.

The present invention relates to a process for removing sulphur-containing contaminants, including hydrogen sulphide, from a natural gas stream.

Natural gas comprising H2S and organic sulfur contaminants can originate from various sources. For example, numerous natural gas wells produce sour natural gas, i.e. natural gas comprising H2S and optionally other contaminants. Natural gas is a general term that is applied to mixtures of light hydrocarbons and optionally other gases (nitrogen, carbon dioxide, helium) derived from natural gas wells. Natural gas is comprised substantially of methane, normally greater than 50 mole %, typically greater than 70 mol % methane. Further, often other hydrocarbons such as ethane, propane, butane or higher hydrocarbons are present.

The gas stream to be treated in accordance with the present invention can be any natural gas stream comprising sulphur-containing contaminants. The process according to the invention is especially suitable for gas streams comprising sulphur-containing contaminants, including hydrogen sulfide and organic sulfur compounds, and carbon dioxide. Suitably the total gas stream to be treated comprises in the range of from 0.1 to 15 vol % hydrogen sulphide, more preferably in the range of from 0.2 to 5 vol % hydrogen sulphide and suitably from 0.5 to 70 vol % carbon dioxide, more preferably in the range of from 1 to 40 vol % carbon dioxide, even more preferably in the range of from 1 to 20 vol % carbon dioxide, and even more preferably from 1 to 10 vol % of carbon dioxide based on the total gas stream. Preferably, the gas stream to be treated comprises high levels of organic sulfur containing compounds, with high levels meaning in the range of from 0.01 to 1 vol % of organic sulfur containing compounds based on the total gas stream. The hydrogen sulfide over carbon dioxide ratio is preferably low, preferably at most 0.90, more preferably at most 0.50, even more preferably at most 0.35, even more preferably at most 0.2, and even more preferably in the range of from 0.05 to 0.2.

In step (a) of the process of the invention the gas stream comprising natural gas, hydrogen sulfide, organic sulfur compounds and carbon dioxide is directed to a first absorption unit. In this first absorption unit, hydrogen sulfide is being absorbed, resulting in a hydrogen sulfide lean gas stream and a hydrogen sulfide rich absorbent. Preferably, this first absorption unit is operated at a pressure in the range of from 10 to 200 bar, more preferably in the range of from 30 to 100 bar. Preferably, the first absorption unit is operated at a temperature in the range of from 10 to 80° C., more preferably in the range of from 20 to 60° C.

Preferably, the first absorption unit comprises a hydrogen sulfide selective absorbent. Suitably, the hydrogen sulfide selective absorbent comprises water, and an amine. Additionally, a physical solvent can be present.

Suitable amines to be used in the first absorption unit include primary, secondary and/or tertiary amines, especially amines that are derived of ethanolamine, especially monoethanol amine (MEA), diethanolamine (DEA), triethanolamine (TEA), diisopropanolamine (DIPA) and methyldiethanolamine (MDEA) or mixtures thereof. A preferred amine is a secondary or tertiary amine, preferably an amine compound derived from ethanol amine, more especially DIPA, DEA, MMEA (monomethyl-ethanolamine), MDEA, or DEMEA (diethyl-monoethanolamine), preferably DIPA or MDEA, more preferably MDEA. The advantage of MDEA is that it has preferential affinity for hydrogen sulfide over carbon dioxide.

Suitable physical solvents are sulfolane (cyclo-tetramethylenesulfone and its derivatives), aliphatic acid amides, N-methylpyrrolidone, N-alkylated pyrrolidones and the corresponding piperidones, methanol, ethanol and mixtures of dialkylethers of polyethylene glycols or mixtures thereof. The preferred physical solvent is sulfolane.

The hydrogen sulfide rich absorbent from the first absorption unit is provided to a first regenerator in step (c) of the process, to obtain a lean absorbent and a hydrogen sulfide rich gas stream.

In step (c) hydrogen sulphide will be removed from at least part of the hydrogen sulphide-enriched absorption solvent as obtained in step (a) to obtain a hydrogen sulphide-depleted absorption solvent and a hydrogen sulphide-enriched gas stream. Hence, step (c) suitably comprises the regeneration of the sulphur compounds-enriched absorption solvent. In step (c) the sulphur compounds-enriched absorption solvent is suitably contacted with regeneration gas and/or heated and can be depressurised, thereby transferring at least part of the contaminants to the regeneration gas. Typically, regeneration takes place at relatively low pressure and high temperature. The regeneration in step (c) is suitably carried out by heating in a regenerator at a relatively high temperature, suitably in the range of from 110-160° C. The heating is preferably carried out with steam or hot oil. Alternatively, a direct fired reboiler can be applied, if desired. Suitably, regeneration is carried out at a pressure in the range of from 1.1-1.9 bara. After regeneration, regenerated absorption solvent (i.e. a hydrogen sulphide-depleted absorption solvent) is obtained and a regeneration gas stream enriched with contaminants such as hydrogen sulphide and carbon dioxide. Suitably, at least part of the hydrogen sulphide-depleted absorption solvent is recycled to step (a). Preferably, the entire hydrogen sulphide-depleted absorption solvent is recycled to step (a). Suitably the regenerated absorption solvent is heat exchanged with contaminants enriched absorption solvent to use the heat elsewhere.

The hydrogen sulfide rich gas of step (c) now has a preferred concentration of H2S in the range of from 40 to 100 vol %, more preferably from 50 to 90 vol %, the remainder of the gas being mainly carbon dioxide. With this amount of H2S, it is sent in step (d) to a Claus unit comprising a Claus furnace and a Claus catalytic stage to convert the hydrogen sulfide to obtain sulfur and a Claus tail gas.

In step (d) hydrogen sulphide present can be reacted with sulphur dioxide at elevated temperature in a first catalytic stage to obtain a gas stream which comprises sulphur and water. Suitably step (d) comprises a catalytic step of a Claus process as described hereinabove. Suitably, the first catalytic stage is carried out in a catalytic zone where hydrogen sulphide reacts with sulphur dioxide to produce more sulphur. Suitably, the reaction in the first catalytic stage is carried out with a Claus conversion catalyst at a temperature in the range of from 204-371° C., preferably in the range of from 260-343° C., and a pressure in the range of from 1-2 bara, preferably in the range of from 1.4-1.7 bara. Suitably, a second and a third catalytic stage can be used in step (d) in which stages use is made of a Claus conversion catalyst. Suitably, in such a second and third catalytic stage the reaction is carried out at a temperature which is 5 to 20° C. above the sulphur dew point, preferable at a temperature which is 10 to 15° C. above the sulphur dew point, and a pressure in the range of from 1-2 bara, preferably in the range of from 1.4-1.7 bara. Preferably, the molar ratio of hydrogen sulphide to sulphur dioxide in step (d) is in the range of from 2:1-3:1.

Sulphur condensation units can suitably be applied after each catalytic stage in step (d), which condensation units can suitably be operated at temperature in the range of from range 160-171° C., preferable in the range of from 163-168° C.

The remaining gases as obtained after condensation of sulphur from the gases leaving the final catalytic zone are usually referred to as “Claus tail gases”. These gases contain nitrogen, water vapour, some hydrogen sulphide, sulphur dioxide and usually also carbon dioxide, carbon monoxide, carbonyl sulphide and carbon disulphide, hydrogen, and small amounts of elemental sulphur.

A suitable Claus catalyst has for instance been described in European patent application No. 0038741, which catalyst substantially consists of titanium oxide. Other suitable catalysts include activated alumina and bauxite catalysts.

In step (d) sulphur is separated from the gas stream, thereby obtaining a hydrogen sulphide-lean gas stream. To that end the gas stream as obtained in step (d) can be cooled below the sulphur dew point to condense and subsequently most of the sulphur obtained can be separated from the gas stream, thereby obtaining the hydrogen sulphide-depleted gas stream.

In step (b), the hydrogen sulfide lean gas stream is send to a second absorption unit. This second absorption unit absorbs the organic sulfur compounds and the carbon dioxide, present in the gas stream. The resulting cleaned gas stream can be further used, for example in a power plant, or as a feed to an LNG or Gas to Liquids process. The second absorption unit is preferably operated at a pressure in the range of from 10 to 200 bar, more preferably in the range of from 30 to 100 bar. It comprises preferably a hybrid solvent, more preferably Sulfinol, even more preferably Sulfinol-X. Besides a cleaned gas stream, also an absorbent rich in organic sulfur compounds and carbon dioxide is being formed.

The absorbent rich in organic sulfur compounds and in carbon dioxide is being send to a second regenerator to obtain a lean absorbent and a gas stream rich in organic sulfur compounds and in carbon dioxide (step (e)). The resulting gas stream rich in organic sulfur compounds and in carbon dioxide is fully oxidized in step (f) to convert all sulfur species of the to obtain a sulfur dioxide rich gas stream.

This sulfur dioxide rich stream is cooled in step (g) to obtain steam, water and a cooled sulfur dioxide rich gas stream. This cooled sulfur dioxide rich gas stream is concentrated in step (h) by providing it to a third absorption unit. A most preferred manner for sulphur dioxide concentration is by contacting the cooled sulfur dioxide rich gas stream with an absorbing liquid for sulphur dioxide in a sulphur dioxide absorption zone to selectively transfer sulphur dioxide from the cooled sulfur dioxide rich gas stream to the absorbing liquid to obtain sulphur dioxide-enriched absorbing liquid and subsequently regeneration via stripping of sulphur dioxide from the sulphur dioxide-enriched absorbing liquid to produce a lean absorbing liquid and the sulphur dioxide-containing gas. Regeneration of the sulfur dioxide rich absorbent in step (i) is performed in a third regenerator. This results in a lean absorbent, a purified sulfur dioxide gas stream and a sulfur dioxide lean gas stream.

One preferred absorbing liquid for sulphur dioxide comprises at least one substantially water immiscible organic phosphonate diester.

Another preferred absorbing liquid for sulphur dioxide comprises tetraethyleneglycol dimethylether.

Yet another preferred absorbing liquid for sulphur dioxide comprises diamines having a molecular weight of less than 300 in free base form and having a pKa value for the free nitrogen atom of about 3.0 to about 5.5 and containing at least one mole of water for each mole of sulphur dioxide to be absorbed.

Stripping of sulphur dioxide from the sulphur dioxide-enriched absorbing liquid is usually done at elevated temperature. To provide a more energy-efficient process, steam generated in a heat recovery steam generator unit can be used to provide at least part of the heat needed for the stripping of sulphur dioxide from the sulphur dioxide-enriched absorbing liquid.

The third regenerator is preferably operated at a pressure in the range of from 1 to 10 bar, more preferably from 1 to 5 bar.

In a preferred embodiment of the invention, the purified sulfur dioxide gas stream as obtained in step (i) is sent to the Claus furnace or to the Claus catalytic stage of step (d). In the Claus unit the sulfur dioxide is reduced to elemental sulfur which is a more stable and easier to store and dispose compound, as compared to sulfur dioxide.

Normally, the Claus tail gas from step (d) needs further treatment in a so-called SCOT unit. However, in a preferred embodiment of the invention, the Claus tail gas from step (d) is combined with the gas stream rich in organic sulfur compounds and in carbon dioxide of step (e) before it is fully oxidized in step (f). In this way no SCOT unit is needed, which saves on energy and reactors, including all related equipment.

In step f) of the process according to the invention all sulfur species of the gas stream rich in organic sulfur compounds and in carbon dioxide are oxidized, preferably with an oxygen containing gas. The oxygen containing gas might be pure oxygen, or air, or oxygen-enriched air. In order to omit the need to separate air to provide oxygen-enriched air or pure oxygen it is preferred to use air to combust the hydrogen sulphide.

The hydrogen sulfide rich gas as obtained in step (c) might be further treated in a fourth absorption unit to obtain an enriched hydrogen sulfide rich gas, before the gas is being partially oxidized in a Claus furnace. This is typically done in cases where the gases generated in step (c) do not meet the minimum requirements with respect to hydrogen sulfide content to be sent to the Claus unit. Low hydrogen sulfide content in the feed to the Claus unit can have a detrimental effect on flame stability, decrease in hydrogen sulfide conversion, an increase in fuel consumption, and incomplete destruction of sulfur containing contaminants.

The fourth absorption unit optionally treats the hydrogen sulfide rich gas as obtained in step (c). Therefore the process of the invention preferably comprises an additional step (j), wherein the hydrogen sulfide rich gas as obtained in step (c) is directed to a fourth absorption unit. In this fourth absorption unit, hydrogen sulfide is being absorbed, resulting in a hydrogen sulfide lean gas stream and a hydrogen sulfide rich absorbent. Preferably, this fourth absorption unit is operated at a pressure in the range of from 1 to 4 bar, more preferably in the range of from 1.2 to 3 bar. Preferably, the fourth absorption unit is operated at a temperature in the range of from 10 to 70° C., more preferably in the range of from 20 to 60° C.

Preferably, the fourth absorption unit comprises a hydrogen sulfide selective absorbent. Suitably, the hydrogen sulfide selective absorbent comprises water, and an amine. Additionally, a physical solvent can be present.

Suitable amines to be used in the first absorption unit include primary, secondary and/or tertiary amines, especially amines that are derived of ethanolamine, especially monoethanol amine (MEA), diethanolamine (DEA), triethanolamine (TEA), diisopropanolamine (DIPA) and methyldiethanolamine (MDEA) or mixtures thereof. A preferred amine is a secondary or tertiary amine, preferably an amine compound derived from ethanol amine, more especially DIPA, DEA, MMEA (monomethyl-ethanolamine), MDEA, or DEMEA (diethyl-monoethanolamine), preferably DIPA or MDEA, more preferably MDEA. The advantage of MDEA is that it has preferential affinity for hydrogen sulfide over carbon dioxide.

Suitable physical solvents are sulfolane (cyclo-tetramethylenesulfone and its derivatives), aliphatic acid amides, N-methylpyrrolidone, N-alkylated pyrrolidones and the corresponding piperidones, methanol, ethanol and mixtures of dialkylethers of polyethylene glycols or mixtures thereof. The preferred physical solvent is sulfolane.

The hydrogen sulfide rich absorbent from the first absorption unit is provided to a fourth regenerator, to obtain a lean absorbent and a hydrogen sulfide rich gas stream. This hydrogen sulfide rich gas stream can be partially oxidized in a Claus furnace.

The hydrogen sulfide lean gas stream from the fourth absorption unit is preferably combined with the gas stream rich in organic sulfur compounds and in carbon dioxide of step (e) before entering step (f).

1. A process for removing sulfur-containing contaminants from a gas stream, the process comprising the steps of:
(a) providing a gas stream comprising natural gas, hydrogen sulfide, organic sulfur compounds and carbon dioxide to a first absorption unit, resulting in a hydrogen sulfide lean gas stream and a hydrogen sulfide rich absorbent;
(b) providing the hydrogen sulfide lean gas stream to a second absorption unit, resulting in a cleaned gas stream and an absorbent rich in organic sulfur compounds and in carbon dioxide;
(c) providing a first regenerator with the hydrogen sulfide rich absorbent from the first absorption unit, to obtain a lean absorbent and a hydrogen sulfide rich gas stream;
(d) providing the hydrogen sulfide rich gas to a Claus unit comprising a Claus furnace and a Claus catalytic stage to convert the hydrogen sulfide to obtain sulfur and a Claus tail gas;
(e) providing a second regenerator with the absorbent rich in organic sulfur compounds and in carbon dioxide to obtain a lean absorbent and a gas stream rich in organic sulfur compounds and in carbon dioxide;
(f) fully oxidizing all sulfur species of the gas stream rich in organic sulfur compounds and in carbon dioxide to obtain a sulfur dioxide rich gas stream;
(g) cooling of the sulfur dioxide rich stream to obtain steam, water and a cooled sulfur dioxide rich gas stream;
(h) providing a third absorption unit with the sulfur dioxide rich gas stream to obtain a sulfur dioxide rich absorbent and sulfur dioxide lean gas stream; and
(i) providing a third regenerator with the sulfur dioxide rich absorbent from the third absorption unit, to obtain a lean absorbent and a purified sulfur dioxide gas stream.

2. A process according to claim 1, wherein the purified sulfur dioxide gas stream as obtained in step (i) is sent to the Claus furnace or to the Claus catalytic stage of step (d).

3. A process according to claim 1, wherein the Claus tail gas from step (d) is combined with the gas stream rich in organic sulfur compounds and in carbon dioxide of step (e) before it is fully oxidized in step (f).

4. A process according to claim 1, wherein the first absorption unit is operated at a pressure in the range of from 10 to 200 bar.

5. A process according to claim 1, wherein the absorbent used in the first absorption unit is a hydrogen sulfide selective absorbent.

6. A process according to claim 1, wherein the second absorption unit is operated at a pressure in the range of from 10 to 200 bar.

7. A process according to claim 1, wherein the absorbent used in the second absorption unit is a hybrid solvent.

8. A process according claim 1, wherein the third absorption unit is operated at a pressure in the range of from 1 to 10 bar.

9. A process according to claim 1, wherein the absorbent used in the third absorption unit is a sulfur dioxide specific absorbent.

10. A process according to claim 1, wherein the natural gas stream comprises hydrogen sulfide and carbon dioxide in a ratio of at most 0.35

11. A process according to claim 1, wherein the natural gas stream comprises hydrogen sulfide in the range of from 0.1 to 15 vol % H2S.

12. A process according to claim 1, wherein the hydrogen sulfide rich gas as obtained in step (c) is further treated in a fourth absorption unit to obtain a hydrogen sulfide lean gas stream and an enriched hydrogen sulfide rich gas, before the gas is being partially oxidized in a Claus furnace.

13. A process according to claim 12, wherein the hydrogen sulfide lean gas stream from the fourth absorption unit is combined with the gas stream rich in organic sulfur compounds and in carbon dioxide of step (e) before entering step (f).
